(19) United States
(12) Patent Application Publication
(10) Pub. No.: US 2024/0203216 A1
(43) Pub. Date: Jun. 20, 2024

(54) REGISTRATION DEVICE AND REGISTRATION METHOD

(71) Applicant: Toshiba Tec Kabushiki Kaisha, Tokyo (JP)

(72) Inventors: Sayo SONAGA, Kawasaki Kanagawa (JP); Maki SATO, Yokohama Kanagawa (JP); Yumiko OKUMA, Koganei Tokyo (JP)

(21) Appl. No.: 18/471,103

(22) Filed: Sep. 20, 2023

(30) Foreign Application Priority Data
Dec. 20, 2022 (JP) 2022-203046

(51) Int. Cl. G07G 1/01; G06F 3/04817; G06F 3/0482; G06F 3/0485; G06F 3/0488

(52) U.S. Cl. CPC G07G 1/01; G06F 3/04817; G06F 3/0482; G06F 3/0485; G06F 3/0488

(57) ABSTRACT

According to an embodiment, a registration device for registering commodities in a sales transaction includes a display unit for displaying various screens, a touch panel input unit integrated with the display unit, and a processor. The processor is configured to cause the display unit to display a detail screen for displaying registered commodity information or a preset screen for displaying a plurality of commodity selection buttons for registering commodity information. The processor detects an operation direction of a user input operation on the touch panel input unit, and then switches from a presently displayed screen to another display screen based on the detected operation direction and the presently displayed screen.

### CROSS-REFERENCE TO RELATED APPLICATION

This application is based upon and claims the benefit of priority from Japanese Patent Application No. 2022-203046, filed Dec. 20, 2022, the entire contents of which are incorporated herein by reference.

### FIELD

Embodiments described herein relate generally to a registration device and a registration method for retail stores and the like.

### BACKGROUND

In the related art, a store such as a mass retailer uses a registration device such as a point of sales (POS) terminal for registering commodity information (“commodity registration”). A user of the registration device, for example, a store clerk, may need to switch a screen displayed on a display unit of the registration device when executing commodity registration.

For example, the store clerk may switch between a detail screen on which commodity information is displayed when a bar code (“commodity bar code”) attached to a commodity is read by a scanner, and a preset screen for registering a commodity to which a commodity bar code is not attached. Generally, the registration device displays a screen switching button for switching to another screen on each screen.

However, since various operation buttons are also provided on each screen displayed by the registration device, it may be difficult for the store clerk to immediately recognize the screen switching button. Therefore, the related-art registration device still has room for improvement in operability regarding screen switching.

### BRIEF DESCRIPTION OF THE DRAWINGS

FIG. 1 is a schematic diagram of an accounting system according to a first embodiment.

FIG. 2 is a perspective view of a registration device.

FIG. 3 is a hardware block diagram of a registration device.

FIG. 4 is a diagram showing an example of a data configuration of a screen setting file.

FIG. 5 is a diagram showing an example of a virtual screen layout image.

FIG. 6 is a diagram showing another example of a data configuration of the screen setting file.

FIG. 7 is a diagram showing another example of the virtual screen layout image.

FIG. 8 is a functional block diagram of a control unit.

FIG. 9 is a diagram illustrating a switching from a detail screen to a preset screen.

FIG. 10 is a diagram illustrating a switching from a detail screen to a task menu screen.

FIG. 11 is a diagram showing a partial task menu screen.

FIG. 12 is a diagram showing the preset screen.

FIG. 13 is a flowchart of display switching processing by a control unit.

FIG. 14 is a diagram showing an example of a data configuration of a screen setting file stored in a storage unit of a registration device according to a second embodiment.

FIG. 15 is a flowchart of display switching processing by a control unit.

FIG. 16 is a diagram illustrating a switching from a detail screen to a preset screen in a registration device according to a third embodiment.

FIG. 17 is a diagram showing classification icons on a detail screen.

FIG. 18 is a diagram showing an accounting screen in a registration device according to a fourth embodiment.

### DETAILED DESCRIPTION

In general, according to one embodiment, there is provided a registration device and a registration method having improved operability regarding screen switching.

According to one embodiment, a registration device for registering commodities in a sales transaction or the like includes a display unit for displaying various screens, a touch panel input unit integrated with the display unit, and a processor. The processor is configured to cause the display unit to display a detail screen for displaying registered commodity information or a preset screen for displaying a plurality of commodity selection buttons for registering commodity information. The processor is configured to detect an operation direction of a user input operation on the touch panel input unit, and then switch from a presently displayed screen to another display screen based on the detected operation direction and the presently displayed screen.

Hereinafter, a registration device and a registration method according to certain example embodiments will be described with reference to the drawings. The disclosure is not limited by these specific example embodiments. The registration device in an example is for a semi-self POS system in which a store clerk performs an operation related to commodity registration and a customer performs an operation related to payment, but the disclosure is not limited thereto. In other examples, the registration device may be a POS terminal in which a store clerk performs both the operation related to commodity registration and payment.

The registration device executes commodity registration by registering commodity information in its own storage unit in the examples described below, but the disclosure is not limited thereto. The registration device may register the commodity information in a store server separately managed by a store, for example. More specifically, the registration device may temporarily store input commodity identification information, transmit the commodity identification information to the store server, and cause the store server to register commodity information corresponding to the commodity identification information. In other words, the registration device may temporarily store (register) the commodity identification information that is a part of the commodity information. In this specification, registration of the commodity information by the registration device is a concept including registration of the commodity information in a local storage unit and registration of the commodity information in an external storage device after the input of commodity identification information at the registration device.

### First Embodiment

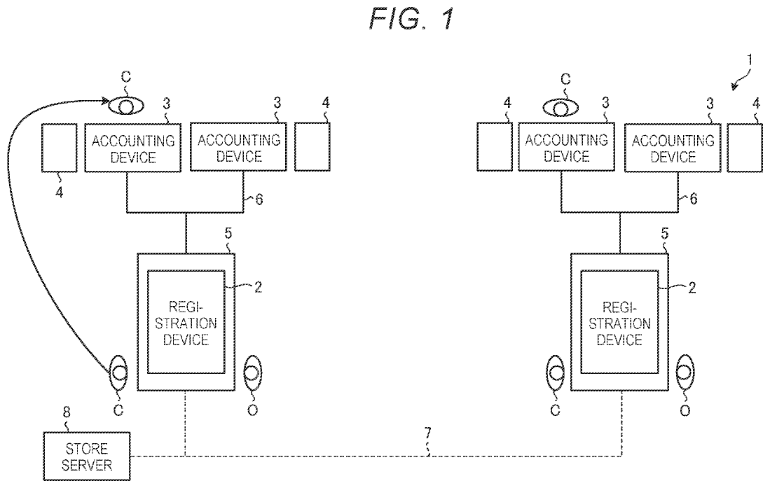

FIG. 1 is a schematic diagram showing a configuration example of an accounting system 1 according to the embodiment. As shown in FIG. 1, the accounting system 1 includes a plurality of registration devices 2 and a plurality of accounting devices 3. Each registration device 2 is installed on a counter 5. A placement table 4 for a commodity basket is installed next to each accounting device 3. Two accounting devices 3 are communicably connected to each registration device 2 via a connection interface 6.

The registration device 2 is operated by a store clerk O. The registration device 2 executes registration processing for a commodity being purchased by a customer C. The registration processing includes commodity registration and calculation of a total amount (transaction amount). The accounting device 3 is operated by the customer C. The accounting device 3 acquires transaction data from the registration device 2 and executes accounting processing accordingly. The transaction data is data necessary for the customer to make payment at the accounting device 3, and includes commodity information (commodity name, unit price, quantity, and the like) regarding the registered commodities and a transaction amount thereof. The accounting processing is processing executed by the accounting device 3 in order for the customer to make a payment. When the registration device 2 registers the commodity information in a store server 8, the accounting device 3 acquires the transaction information from the store server 8 rather than the registration device 2.

An outline of a transaction flow of the customer C by the accounting system 1 is as follows. For example, the registration device 2 generates transaction data including commodity information on a purchased commodity of the customer C and a transaction amount thereof. The registration device 2 selects one of the accounting devices 3 connected thereto as a data transfer destination and transfers the transaction data. The customer C moves to the accounting device 3 to which the transaction data is transferred from the registration device 2, and operates the accounting device 3 to make payment.

The registration device 2 is connected to the store server 8 installed in a backyard of a store via a network 7 such as a local area network (LAN). The store server 8 manages various types of information on the store.

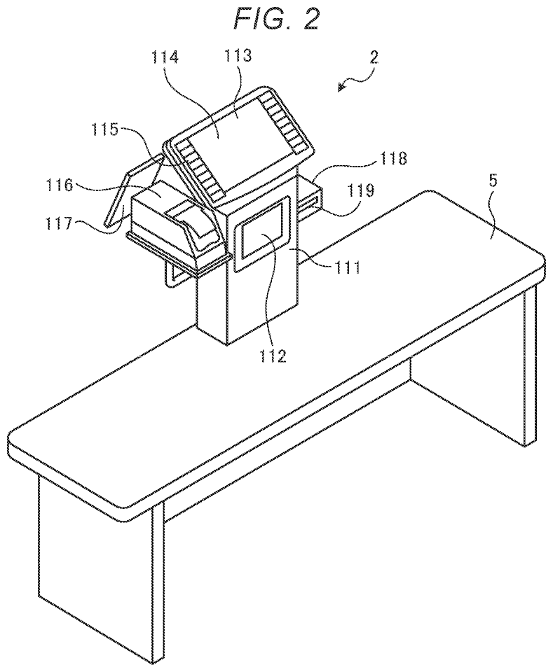

Next, a schematic configuration of the registration device 2 will be described. FIG. 2 is a perspective view showing an appearance of the registration device 2.

As shown in FIG. 2, the registration device 2 installed on an upper surface of the counter 5 is based on a vertical scanner 111 including a reading window 112. The scanner 111 reads a commodity code (commodity identification information) from a captured image of a commodity bar code, for example. The scanner 111 may read the commodity code by scanning the commodity bar code and analyzing received laser light. The scanner 111 may read or obtain the commodity code from an appearance of a commodity using generic object recognition (object recognition).

The registration device 2 includes an operator display 114 and a keyboard 115 on an upper portion of the scanner 111. The operator display 114 displays a detail screen for displaying registered commodity information, a preset screen for registering commodity information on a commodity to which a commodity bar code is not attached, a task menu screen for the store clerk O to do a task different from commodity registration such as commodity return processing, and various other screens. The operator display 114 is an example of a display unit.

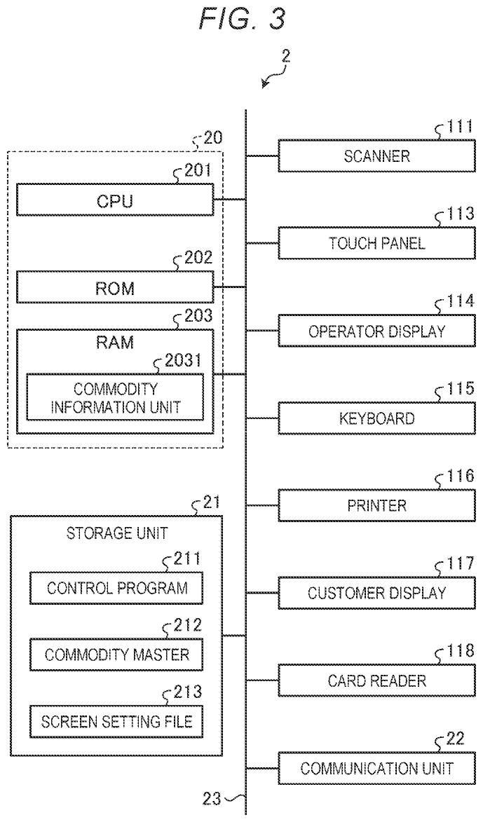

A touch panel 113 is provided on a surface of the operator display 114. The touch panel 113 inputs, to a control unit 20 (see FIG. 3) of the registration device 2, information according to a position touched by a user, and is an example of an input unit provided on a surface of the display unit. The touch panel 113 may be a non-contact touch panel that recognizes an operation of the user without contact with the user and inputs information to the control unit 20. The touch panel 113 and the keyboard 115 function as a user interface that assists input of various types of information such as a commodity code. In the present embodiment, since the user of the registration device 2 is the store clerk O, the user is assumed to be the store clerk O in the following description.

In FIG. 2, a printer 116 is provided on a left side of the registration device 2 (a left side of the registration device when viewed from a position where the store clerk O stands). The printer 116 prints and issues a receipt. For example, when the customer C makes payment with a cash voucher or the like using the registration device 2, the printer 116 issues a receipt.

In FIG. 2, a card reader 118 is provided on a right side of the registration device 2. The card reader 118 magnetically reads information from a magnetic card inserted from an insertion port 119 and writes information to the magnetic card. The card reader 118 may be an IC card reader that reads information from an IC card. For example, the card reader 118 reads member information from a membership card owned by the customer C.

On a back side (a side where the customer C is located) of the printer 116, a customer display 117 is provided with a display surface thereof facing an opposite side of a display surface of the operator display 114. The customer display 117 displays registered commodity information and the like for the customer C.

When the customer C places a basket containing a purchased commodity on a right side of the counter 5 in FIG. 2, the store clerk O takes out the commodity from the basket, holds a commodity bar code in front of the reading window 112, and reads a commodity code by the scanner 111. The registration device 2 executes commodity registration based on the read commodity code.

Next, a hardware configuration of the registration device 2 will be described. FIG. 3 is a block diagram showing a main hardware configuration of the registration device 2.

The registration device 2 includes the control unit 20, a storage unit 21, the scanner 111, the touch panel 113, the operator display 114, the keyboard 115, the printer 116, the customer display 117, the card reader 118, and a communication unit 22. The control unit 20, the storage unit 21, the scanner 111, the touch panel 113, the operator display 114, the keyboard 115, the printer 116, the customer display 117, the card reader 118, and the communication unit 22 are connected to one another via a bus 23 or the like.

The control unit 20 has a computer configuration including a central processing unit (CPU) 201, a read only memory (ROM) 202, and a random access memory (RAM) 203. The CPU 201, the ROM 202, and the RAM 203 are connected to one another via the bus 23.

The CPU 201 controls an overall operation of the registration device 2. The ROM 202 stores various programs such as programs used for driving the CPU 201 and various data. The RAM 203 is used as a work area for the CPU 201, and loads various programs and various data stored in the ROM 202 and the storage unit 21. The control unit 20 executes various types of control processing on the registration device 2 when the CPU 201 functions according to a control program stored in the ROM 202 or the storage unit 21 that is loaded in the RAM 203.

The RAM 203 includes a commodity information unit 2031. The commodity information unit 2031 stores commodity information on a commodity purchased by the customer. Specifically, the commodity information unit 2031 stores the commodity information read from the storage unit 21 based on a commodity code acquired from the scanner 111. The commodity information unit 2031 stores commodity information such as a commodity code, a commodity name, a price, and a quantity in association with one another. Registration of the commodity information in the commodity information unit 2031 is also referred to as commodity registration.

The storage unit 21 can be a storage medium such as a hard disk drive (HDD) or a flash memory, and maintains stored contents even when power is turned off. The storage unit 21 stores a control program 211, a commodity master 212, and a screen setting file 213.

The control program 211 is a program for implementing the functions for executing commodity registration, transferring transaction data including registered commodity information to the accounting device 3, displaying various types of information on the operator display 114 or the customer display 117, detecting an operation direction (e.g., a swipe direction) of the store clerk O on the touch panel 113, specifically, a direction of a swipe operation of the store clerk O, and the like.

The commodity master 212 is a master file for storing commodity information on commodities handled in the store. The commodity master 212 stores a commodity code and other commodity information (e.g., a commodity name, a price, and the like) in association with one another. Since the commodities handled in the store change daily, the registration device 2 acquires the appropriately updated commodity master 212 from the store server 8 or the like.

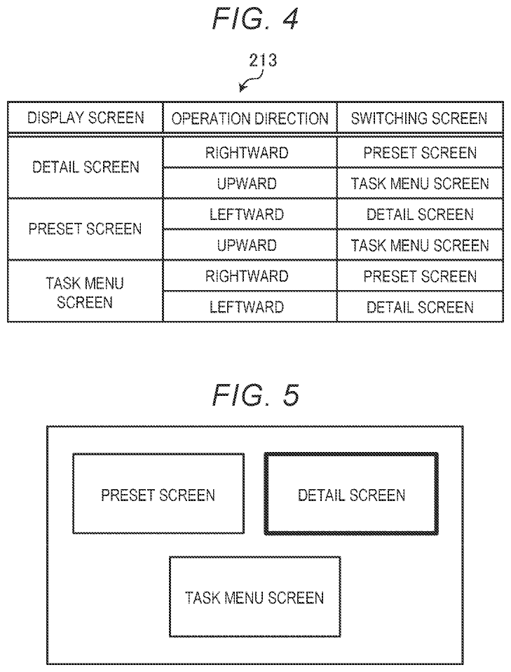

The screen setting file 213 is a file for setting a method of switching screens displayed on the operator display 114. The screens for which the switching method is set in the screen setting file 213 include a detail screen, a preset screen, and a task menu screen in the present embodiment, and the switching method may be set in the screen setting file 213 for other screens as well. The screen setting file 213 can be set as desired by the store using the registration device 2. FIG. 4 is a diagram showing a data configuration of the screen setting file 213. The screen setting file 213 stores a display screen, an operation direction, and a switching screen in association with one another.

The display screen is a screen to be displayed on the operator display 114. In the first embodiment, the detail screen, the preset screen, and the task menu screen are registered. The detail screen, the preset screen, and the task menu screen are screens that can be displayed during a commodity registration operation by the store clerk O and are switched based on the operation (input) of the store clerk O. In particular, since the detail screen and the preset screen are screens that are frequently used during commodity registration, facilitating a switching operation between the two greatly contributes to improvement of operability of the commodity registration operation by the store clerk O. In the first embodiment, the switching method is set in the screen setting file 213 in order to facilitate the method of switching among the detail screen, the preset screen, and the task menu screen.

The operation direction is an operation direction of the store clerk O on the touch panel 113. Specifically, the operation direction is a direction of a swipe operation on the touch panel 113 by the store clerk O. The swipe operation is an operation of sliding a finger in one direction while touching the touch panel 113. For example, when the store clerk O slides the finger rightward while touching the touch panel 113, the operation direction of the store clerk O on the touch panel 113 is “rightward”.

In the following description, a position where the store clerk O first touches the touch panel 113 in a swipe operation may be referred to as a start point, and a position where the finger is removed from the touch panel 113 after sliding may be referred to as an end point. When the operation direction of the swipe is “rightward”, a left side is a start point side and a right side is an end point side. In the screen setting file 213, different operation directions are associated with display screens.

In this context, the “switching screen” is the screen to which the display is switched to by a swipe operation on the presently displayed screen (“display screen”). In other words, the “switching screen” is a screen displayed after a predetermined swipe operation is performed by the store clerk O on the presently displayed screen (“display screen”). The switching screen can be associated with the swipe operation direction on a one-to-one basis.

Here, switching among the detail screen, the preset screen, and the task menu screen will be described with reference to FIG. 5. FIG. 5 is a diagram showing an example of a so-called “virtual screen layout image.” The virtual screen layout image has the preset screen on a left side, the detail screen on a right side, and the task menu screen on a lower side.

A case of switching from a state in which the detail screen is displayed on the operator display 114 to the preset screen will be described. In the virtual screen layout image (FIG. 5), the preset screen is located to the left of the detail screen. The store clerk O may swipe rightward on the detail screen with a mental image of pulling out the preset screen from the left side of the currently displayed detail screen. Specifically, the store clerk O may swipe rightward on the detail screen. In this case, in the screen setting file 213, the display screen column value is the “detail screen”, and the switching screen value associated with an operation direction “rightward” is the “preset screen”. Therefore, the operator display 114 is switched from the detail screen to the preset screen.

When switching from the detail screen to the task menu screen, the store clerk O may swipe upward on the detail screen with an image of pulling out the task menu screen from below the currently displayed detail screen. In this case, in the screen setting file 213, when the display screen value is the “detail screen”, and the switching screen value associated with an operation direction “upward” is the “task menu screen”. Therefore, the operator display 114 is switched from the detail screen to the task menu screen. The task menu screen is an example of another operation screen.

Other screens can be switched to or from in a similar manner. The store may arrange a diagram showing the virtual screen layout image at a position visible to the store clerk O who operates the registration device 2, whereby screen switching can be reliably performed by the operation of the store clerk O. Next, a modification of the screen setting file 213

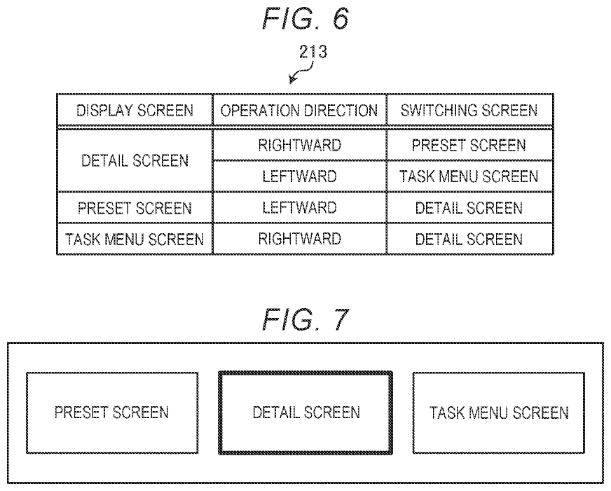

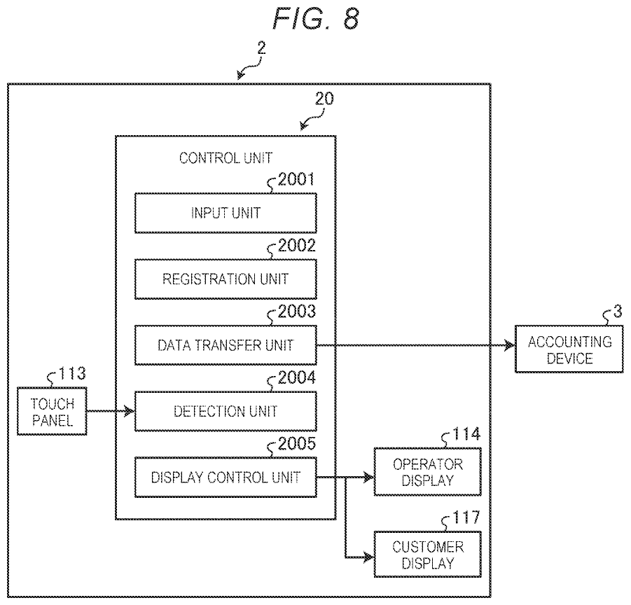

will be described. FIG. 6 is a diagram showing a data configuration of the screen setting file 213 according to this modification. FIG. 7 is a diagram showing a virtual screen layout image corresponding to the screen setting file 213 depicted in FIG. 6. In the virtual screen layout image shown in FIG. 7, a preset screen is located to the left of a detail screen, and a task menu screen is located to the right of the detail screen.

When switching from the detail screen to the preset screen, the store clerk O may swipe rightward on the detail screen with a mental image of pulling the preset screen rightward from the left side of the detail screen. In this case, in the screen setting file 213 in FIG. 6, a display screen value is the “detail screen”, and a switching screen value associated with an operation direction “rightward” is the “preset screen”. Therefore, the operator display 114 can be switched from the detail screen to the preset screen.

When switching from the detail screen to the task menu screen, the store clerk O may swipe leftward on the detail screen with a mental image of pulling the task menu screen leftward from the right side of the detail screen. In this case, in the screen setting file 213 in FIG. 6, the display screen value is the “detail screen”, and the switching screen value associated with an operation direction “leftward” is the “task menu screen”. Therefore, the operator display 114 can be switched from the detail screen to the task menu screen.

Referring back to FIG. 3, hardware of the registration device 2 will be described. The scanner 111, the touch panel 113, the operator display 114, the keyboard 115, the printer 116, the customer display 117, and the card reader 118 have been described above.

The communication unit 22 is an interface for communicating with external devices such as the accounting device 3 and the store server 8. The control unit 20 can transmit and receive information (data) to and from an external device by being connected to the external device via the communication unit 22.

Next, a functional configuration of the control unit 20 of the registration device 2 will be described. FIG. 8 is a block diagram showing a main functional configuration of the control unit 20 of the registration device 2. The control unit 20 functions as an input unit 2001, a registration unit 2002, a data transfer unit 2003, a detection unit 2004, and a display control unit 2005 when the CPU 201 operates according to the control program stored in the ROM 202 or the storage unit 21. Each of the described functions of the control unit 20 may be implemented as hardware such as a dedicated circuit.

Various types of information can be input to the input unit 2001. For example, a commodity code is input to the input unit 2001 from the scanner 111. The commodity code input from the scanner 111 is read from a commodity bar code by the scanner 111. The commodity code corresponding to a commodity selection button detected by the detection unit 2004 when being selected by the store clerk O is input to the input unit 2001. The commodity code corresponding to the commodity selection button is a commodity code of a commodity selected by the store clerk O on the preset screen.

A transaction data transfer instruction is input to the input unit 2001 from the touch panel 113 or the keyboard 115. The transaction data transfer instruction is input by an operation of the store clerk O when commodity registration is completed for all purchased commodities of the customer C.

The registration unit 2002 executes the commodity registration. Specifically, the registration unit 2002 reads, from the commodity master 212, commodity information corresponding to the commodity code input to the input unit 2001. Then, the registration unit 2002 registers the read commodity information in the commodity information unit 2031 as a transaction object (registered commodity).

When the transaction data transfer instruction is input to the input unit 2001, the data transfer unit 2003 transfers transaction data to the accounting device 3. The data transfer unit 2003 may transfer the transaction data to the accounting device 3 designated by the store clerk O or may transfer the transaction data to the accounting device 3 selected by the control unit 20.

The detection unit 2004 detects various operators displayed on the operator display 114 and selected by the store clerk O based on information input from the touch panel 113. For example, the detection unit 2004 detects the commodity selection button that is displayed on the preset screen displayed on the operator display 114 and that is selected by the store clerk O.

The detection unit 2004 detects an operation direction of the store clerk O on the touch panel 113. Specifically, the detection unit 2004 detects a direction of a swipe operation of the store clerk O. The detection unit 2004 determines that a first direction is detected when detecting that the direction of the swipe operation of the store clerk O is a rightward direction on the detail screen.

The detection unit 2004 determines that a second direction is detected when detecting that the direction of the swipe operation of the store clerk O is a leftward direction on the preset screen. The detection unit 2004 determines that a third direction is detected when detecting that the direction of the swipe operation of the store clerk O is an upward direction on the detail screen or the preset screen.

The display control unit 2005 displays various types of information on the operator display 114 and the customer display 117. For example, the display control unit 2005 displays registered commodity information and a transaction amount on the customer display 117.

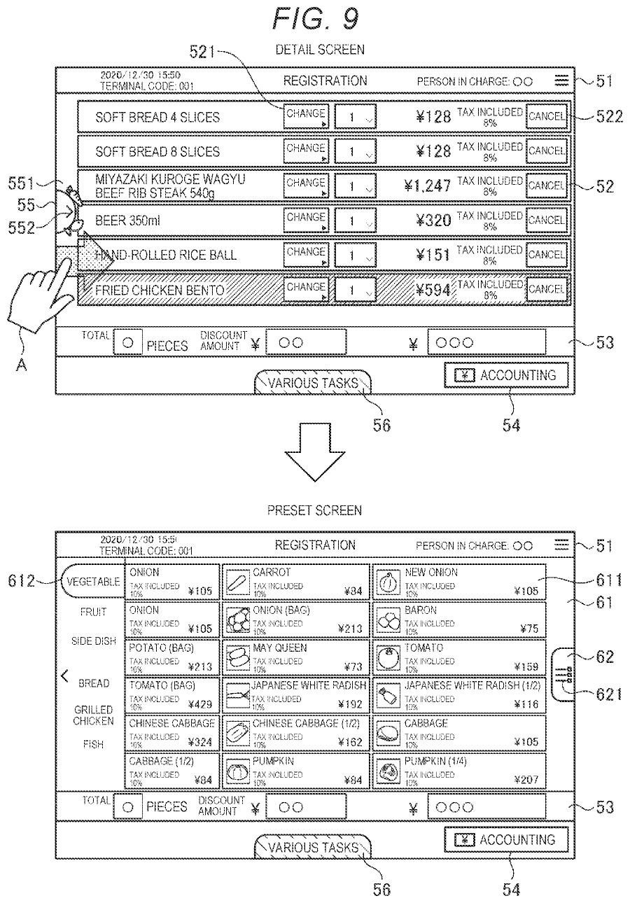

The display control unit 2005 displays the detail screen, the preset screen, and the task menu screen on the operator display 114. The display control unit 2005 switches the preset screen, the task menu screen, and various other screens based on the direction of the swipe operation of the store clerk O, a switching button, and the like detected by the detection unit 2004. Here, aspects of the detail screen, the preset screen, and the task menu screen, and switching among these screens will be described with reference to the drawings. First, switching from the detail screen to the preset screen will be described. FIG. 9 is a diagram showing the switching from the detail screen to the preset screen.

The detail screen displayed on the operator display 114 displays a header portion 51, a detail information portion 52, a total information portion 53, an accounting button 54, a preset display button 55, and a task menu display button 56. The preset display button 55 and the task menu display button 56 are examples of switching buttons for switching the display screen.

The header portion 51 displays a current time, a terminal code, a name of a person in charge, and the like. The terminal code is a code for identifying the registration device 2 displaying the detail screen. The name of the person in charge is a name of the store clerk O who operates the registration device 2 displaying the detail screen. When the name of the person in charge is changed, the task menu screen is displayed to input necessary information.

The detail information portion 52 displays information on a registered commodity. The commodity information to be displayed includes a commodity name, a quantity, a price, a tax category, and the like. The detail information portion 52 displays a quantity change button 521 and a cancel button 522. The quantity change button 521 and the cancel button 522 are displayed for each piece of commodity information to be displayed.

The quantity change button 521 is an operator for changing a quantity of the commodity. After operating the quantity change button 521, the store clerk O inputs the quantity. The quantity may be input from the keyboard 115, or may be input by selecting a number displayed in a pull-down manner in an area where the quantity is displayed. The cancel button 522 is an operator for canceling commodity registration.

The total information portion 53 displays a total quantity and a total amount of registered commodities. When a discounted commodity is included in the registered commodities, the total information portion 53 also displays a total discount amount.

The accounting button 54 is an operator for declaring an end of the commodity registration. When the accounting button 54 is operated, the operator display 114 displays a transfer screen or the like. When the registration device 2 is of a type in which the store clerk O manually selects the accounting device 3 to which the transaction data is to be sent, the operator display 114 displays, as a transfer screen, a screen for selecting an accounting device 3 to serve as the transfer destination. When the registration device 2 is of a type in which the control unit 20 automatically selects which accounting device 3 to send the transaction data, the operator display 114 displays, as a transfer screen, a screen showing information (accounting device No. or the like) for identifying the automatically selected accounting device 3.

The preset display button 55 is an operator for displaying a preset screen. The store clerk O can display the preset screen by operating the preset display button 55 or swiping rightward on the detail screen.

A commodity illustration 551 showing a preset commodity such as a vegetable or fish is additionally displayed on the preset display button 55. Accordingly, the store clerk O can recognize that the preset screen is displayed by operating the preset display button 55. The preset commodity is a commodity to which a commodity bar code is not attached, and a commodity whose commodity code is input by selecting the commodity on the preset screen. An arrow 552 pointing rightward is displayed on the preset display button 55. The store clerk O can recognize from the arrow 552 that the preset screen is to be displayed by swiping rightward.

The preset display button 55 is displayed on the detail screen in a manner of being located on a start point side when a direction of a swipe operation for displaying the preset screen is defined by a start point and an end point. Specifically, on the detail screen, the preset display button 55 is displayed on a left end portion, which is the start point side when swiping rightward. When the store clerk O attempts to swipe rightward on the detail screen, the store clerk O usually swipes rightward from the left end portion of the detail screen. Therefore, the store clerk O can easily recognize the preset display button 55 by providing the preset display button 55 at the left end portion of the detail screen, which is considered to be firstly focused on by the store clerk O who wants to display the preset screen.

As described above, the preset display button 55 can be easily recognized on the detail screen, and the preset screen can be displayed by a swipe operation even if the preset display button 55 cannot be immediately recognized. Therefore, operability of the store clerk O can be improved.

The task menu display button 56 is an operator for displaying the task menu screen. The store clerk O can display the task menu screen by operating the task menu display button 56 or swiping upward on the detail screen.

The task menu display button 56 is displayed on the detail screen in a manner of being located on a start point side when a direction of a swipe operation for displaying the task menu screen is defined by a start point and an end point. Specifically, on the detail screen, the task menu display button 56 is displayed on a lower end portion, which is the start point side when swiping upward. Accordingly, the store clerk O can easily recognize the task menu display button 56 as in a case of the preset display button 55.

In the detail screen shown in FIG. 9, when the store clerk O swipes rightward, for example, as indicated by a symbol A, the operator display 114 displays the preset screen. The detection unit 2004 can detect a direction of a swipe operation regardless of where the swipe operation is performed on the detail screen in the present embodiment, but the disclosure is not limited thereto. In some examples, the detection unit 2004 may detect a direction of a swipe operation only in a part of the detail screen, for example, the left end portion around the preset display button 55 or the lower end portion around the task menu display button 56.

Next, the preset screen will be described. The components the same as those of the detail screen are denoted by the same reference symbols. The preset screen displays the header portion 51, the total information portion 53, the accounting button 54, the task menu display button 56, a commodity selection portion 61, and a detail display button 62.

The commodity selection portion 61 displays a large number of commodity selection buttons 611. The commodity selection button 611 is an operator for inputting a commodity code of a commodity to which a commodity bar code is not attached. The commodity selection buttons 611 are displayed in association with a tab 612. The tab 612 shows a classification of the corresponding commodity selection buttons 611, and can be selected by the store clerk O. The classification shown by the tab 612 includes “vegetable”, “fruit”, “side dish”, “bread”, “grilled chicken”, “fish”, and the like. The commodity selection portion 61 displays the commodity selection buttons 611 for commodities belonging to a selected classification of the tab 612. When another screen is switched to the preset screen, the preset screen displaying the commodity selection buttons 611 for commodities belonging to a classification of the tab 612 of “vegetable” is set as being displayed by default.

The detail display button 62 is an operator for displaying the detail screen. The detail screen can be displayed by the store clerk O operating the detail display button 62 or swiping leftward on the preset screen.

An illustration 621 showing an image of a commodity list is displayed on the detail display button 62. Accordingly, the store clerk O can recognize that the detail screen is displayed by operating the detail display button 62.

The detail display button 62 is displayed on the preset screen in a manner of being located on a start point side when a direction of a swipe operation for displaying the detail screen is defined by a start point and an end point. Specifically, on the preset screen, the detail display button 62 is displayed on a right end portion, which is the start point side when swiping leftward. Accordingly, similarly to the preset display button 55 and the task menu display button 56 on the detail screen, the store clerk O can easily recognize the detail display button 62.

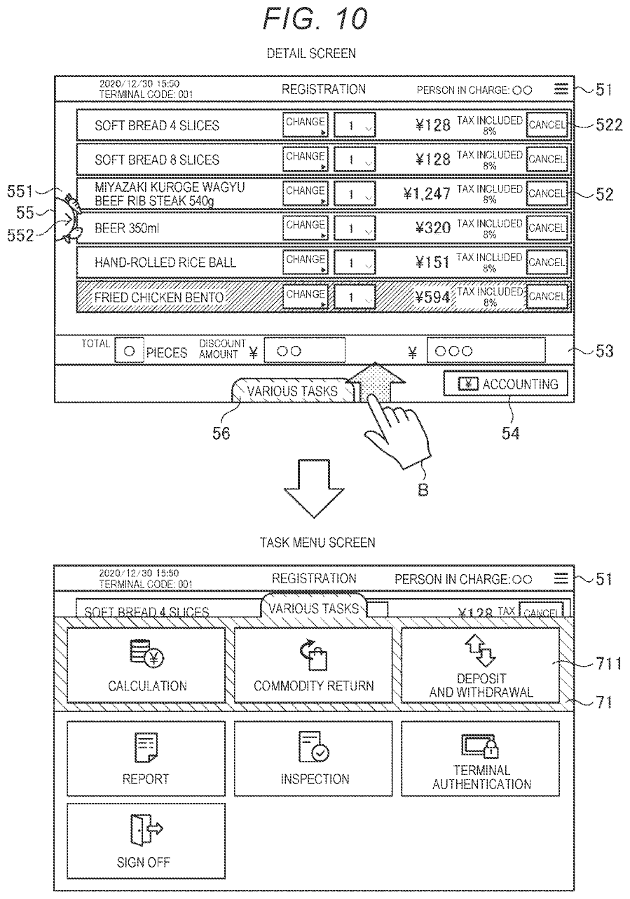

Next, switching from the detail screen to the task menu screen will be described. FIG. 10 is a diagram showing the switching from the detail screen to the task menu screen. Components of the detail screen are the same as those of the detail screen in FIG. 9 and are thus denoted by the same reference symbols.

In the detail screen shown in FIG. 10, when the store clerk O swipes upward, for example, as indicated by a symbol B, the operator display 114 displays the task menu screen. The task menu screen is displayed in a manner of overlapping the detail screen.

The task menu screen displays the header portion 51 and a task menu selection portion 71. The header portion 51 has the same configuration as the header portion 51 on the detail screen, and the description thereof will be omitted. The task menu selection portion 71 displays a plurality of task selection buttons 711. A word showing a content of a task is displayed on each task selection button 711. The store clerk O operates the task selection button 711 related to a content of an own task. When one of the task selection buttons 711 is operated, the operator display 114 displays a screen for performing a task related to the selected (pressed) task selection button 711.

An operator for displaying the detail screen and an operator for displaying the preset screen are not displayed on the task menu screen in the present embodiment, but these operators may be displayed. For example, the preset display button 55 may be displayed at a left end portion of the task menu screen, and the detail display button 62 may be displayed at a right end portion thereof.

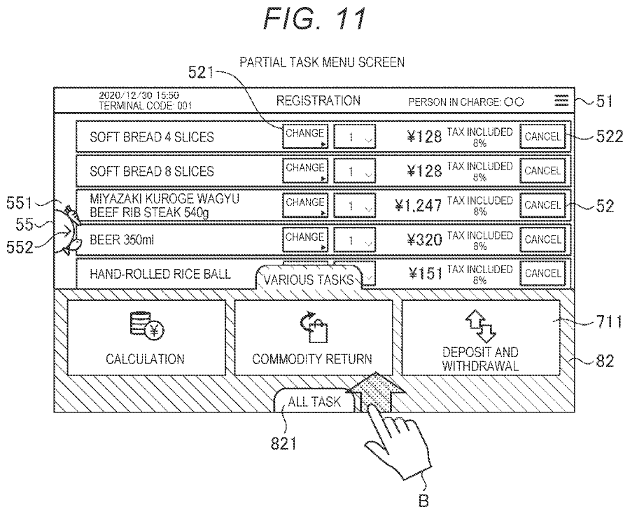

The operator display 114 may display a partial task menu screen shown in FIG. 11 when the store clerk O swipes upward on the detail screen or operates the task menu display button 56.

The partial task menu screen will be described. The components the same as those of the detail screen and the task menu screen described above are denoted by the same reference symbols. The partial task menu screen displays a part of the detail screen and a part of the task menu screen, and includes a detail screen portion 81 and a task menu screen portion 82. The detail screen portion 81 displays the header portion 51, the detail information portion 52, the quantity change button 521, the cancel button 522, preset the display button 55, the commodity illustration 551, and the arrow 552.

The task menu screen portion 82 displays the task selection buttons 711 of a task menu having a high execution frequency in the task menu. The task menu screen portion 82 displays an all task menu display button 821. The all task menu display button 821 is an operator for displaying the task menu screen.

The store clerk O can display the task menu screen by operating the all task menu display button 821 or swiping upward on the partial task menu screen.

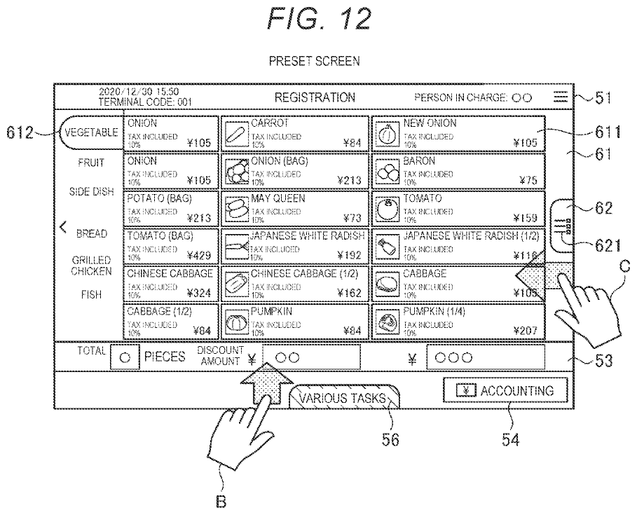

Next, screen switching from the preset screen will be described. The screen switching from the preset screen has the same mechanism as screen switching from the detail screen. FIG. 12 is a diagram showing the preset screen.

On the preset screen, when the detail display button 62 is operated (pressed), or when a swipe operation is performed leftward as indicated by a symbol C, the operator display 114 displays the detail screen. On the preset screen, when the task menu display button 56 is operated (pressed), or when a swipe operation is performed upward as indicated by the symbol B, the operator display 114 displays the task menu screen. When the task menu display button 56 is operated (pressed), or when a swipe operation is performed upward as indicated by the symbol B, the operator display 114 may display the partial task menu screen shown in FIG. 11.

Screen switching from the task menu screen is similar to the screen switching from the detail screen and the screen switching from the preset screen in that the screen switching from the task menu screen can also be executed based on a direction of a swipe operation. Specifically, when the store clerk O swipes leftward on the task menu screen shown in FIG. 10, the operator display 114 displays the detail screen. When the store clerk O swipes rightward on the task menu screen shown in FIG. 10, the operator display 114 displays the preset screen. Screen switching operators such as the preset display button 55 and the detail display button 62 may also be displayed on the task menu screen.

The same applies to switching from the partial task menu screen shown in FIG. 11 to the detail screen and switching from the partial task menu screen to the preset screen. That is, on the partial task menu screen shown in FIG. 11, when the store clerk O swipes leftward, the operator display 114 displays the detail screen, and when the store clerk O swipes rightward, the operator display 114 displays the preset screen.

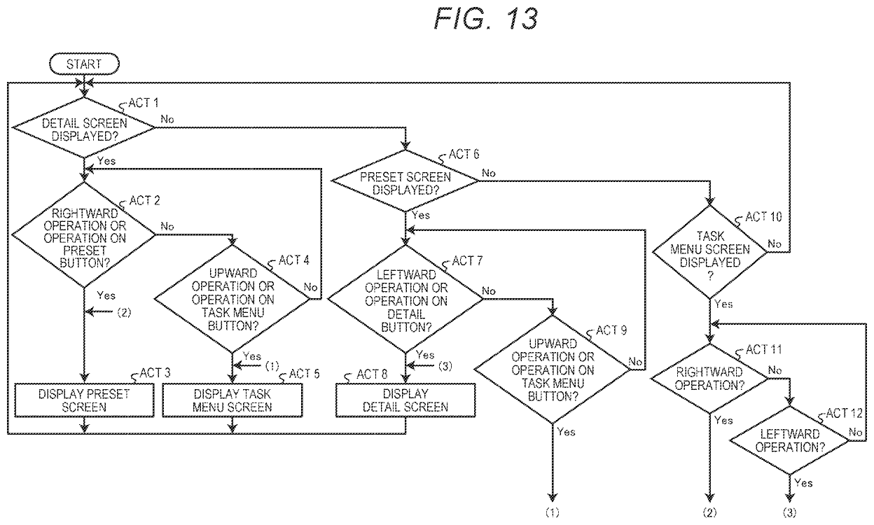

Next, display switching processing for executing the above-described screen switching will be described. The display switching processing is processing of f switching among three screens, namely the detail screen, the preset screen, and the task menu screen. FIG. 13 is a flowchart showing a flow of the display switching processing by the control unit 20 of the registration device 2.

The control unit 20 determines whether the display control unit 2005 displays a detail screen on the operator display 114 (ACT 1). When the detail screen is displayed (Y in ACT 1), the control unit 20 next determines whether the detection unit 2004 detects a rightward swipe operation or an operation on the preset display button 55 on the detail screen (ACT 2).

When the detection unit 2004 detects the rightward swipe operation or the operation on the preset display button 55 (Y in ACT 2), the display control unit 2005 displays a preset screen on the operator display 114 (ACT 3). Then, the control unit 20 returns to the processing of ACT 1.

When the detection unit 2004 does not detect the rightward swipe operation or the operation on the preset display button 55 (N in ACT 2), the control unit 20 next determines whether the detection unit 2004 detects an upward swipe operation or an operation on the task menu display button 56 (ACT 4).

When the detection unit 2004 detects the upward swipe operation or the operation on the task menu display button 56 (Y in ACT 4), the display control unit 2005 displays a task menu screen on the operator display 114 (ACT 5). Then, the control unit 20 returns to the processing of ACT 1. In the processing of ACT 4, when the detection unit 2004 does not detect the upward swipe operation or the operation on the task menu display button 56 (N in ACT 4), the control unit 20 proceeds to the processing of ACT 2.

In the processing of ACT 1, when the detail screen is not displayed (N in ACT 1), the control unit 20 next determines whether the display control unit 2005 displays the preset screen on the operator display 114 (ACT 6). When the preset screen is displayed (Y in ACT 6), the control unit 20 next determines whether the detection unit 2004 detects a leftward swipe operation or an operation on the detail display button 62 on the preset screen (ACT 7).

When the detection unit 2004 detects the leftward swipe operation or the operation on the detail display button 62 (Y in ACT 7), the display control unit 2005 displays the detail screen on the operator display 114 (ACT 8). Then, the control unit 20 returns to the processing of ACT 1.

When the detection unit 2004 does not detect the leftward swipe operation or the operation on the detail display button 62 (N in ACT 7), the control unit 20 next determines whether the detection unit 2004 detects an upward swipe operation or an operation on the task menu display button 56 (ACT 9).

When the detection unit 2004 detects the upward swipe operation or the pressing of the task menu display button 56 (Y in ACT 9), the control unit 20 proceeds to the processing of ACT 5. When the detection unit 2004 does not detect the upward swipe operation or the operation on the task menu display button 56 (N in ACT 9), the control unit 20 proceeds to the processing of ACT 7.

In the processing of ACT 6, when the preset screen is not displayed (N in ACT 6), the control unit 20 next determines whether the display control unit 2005 displays the task menu screen on the operator display 114 (ACT 10).

When the task menu screen is not displayed (N in ACT 10), the control unit 20 returns to the processing of ACT 1. When the task menu screen is displayed (Y in ACT 10), the control unit 20 next determines whether the detection unit 2004 detects a rightward swipe operation on the task menu screen (ACT 11).

When the detection unit 2004 detects the rightward swipe operation (Y in ACT 11), the control unit 20 proceeds to the processing of ACT 3. When the detection unit 2004 does not detect the rightward swipe operation (N in ACT 11), the control unit 20 next determines whether the detection unit 2004 detects a leftward swipe operation (ACT 12).

When the detection unit 2004 detects the leftward swipe operation (Y in ACT 12), the control unit 20 proceeds to the processing of ACT 8. When the detection unit 2004 does not detect the leftward swipe operation (N in ACT 12), the control unit 20 proceeds to the processing of ACT 11.

According to the display switching processing, the store clerk O can switch a display screen of the operator display 114 by performing a swipe operation. Therefore, the screen can be smoothly switched even when the store clerk O cannot immediately recognize a screen switching operator.

### Second Embodiment

Next, a second embodiment will be described. In the first embodiment, a switching screen is selected according to a combination of a display screen and a direction of a swipe operation, whereas in the second embodiment, a switching screen is selected only by a direction of a swipe operation. In the following, the description of the components and functions that are the same as those according to the first embodiment may be omitted.

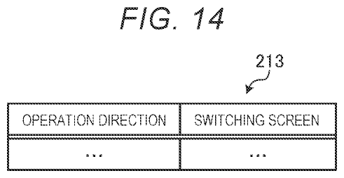

FIG. 14 is a diagram showing a data configuration of the screen setting file 213. The screen setting file 213 stores an operation direction and a switching screen in association with each other. Since the screen is switched based on setting of the screen setting file 213 in which only the operation direction and the switching screen are associated, the store clerk O who performs a screen switching operation may only recognize a relationship between a direction of a swipe operation and the switching screen.

In the second embodiment, screen switching operators are not displayed on a detail screen, a preset screen, and a task menu screen, but may be displayed on each of the screens.

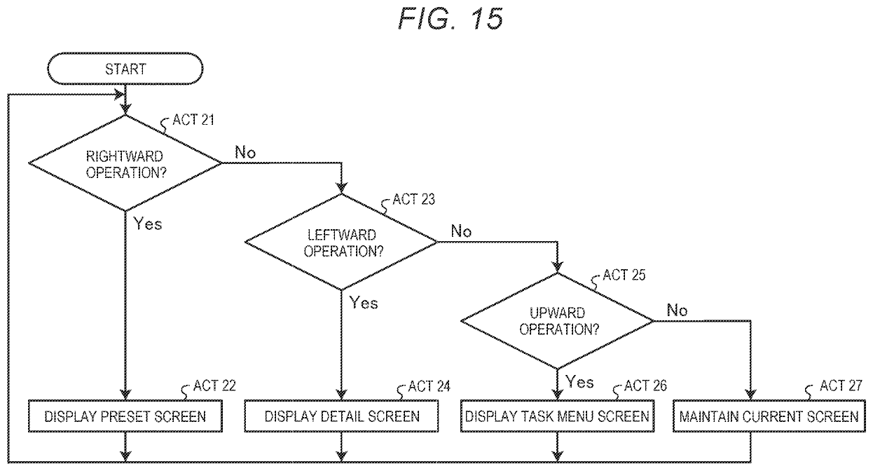

FIG. 15 is a flowchart showing a flow of display switching processing by the control unit 20 of the registration device 2. The display switching processing according to the second embodiment is also processing of switching among three screens, namely the detail screen, the preset screen, and the task menu screen.

The control unit 20 determines whether the detection unit 2004 detects a rightward swipe operation on any one of the detail screen, the preset screen, and the task menu screen (ACT 21). When the detection unit 2004 detects the rightward swipe operation (Y in ACT 21), the display control unit 2005 displays the preset screen on the operator display 114 (ACT 22). Then, the control unit 20 returns to the processing of ACT 21.

When the detection unit 2004 does not detect the rightward swipe operation (N in ACT 21), the control unit 20 next determines whether the detection unit 2004 detects a leftward swipe operation (ACT 23). When the detection unit 2004 detects the leftward swipe operation (Y in ACT 23), the display control unit 2005 displays the detail screen on the operator display 114 (ACT 24). Then, the control unit 20 returns to the processing of ACT 21.

When the detection unit 2004 does not detect the leftward swipe operation (N in ACT 23), the control unit 20 next determines whether the detection unit 2004 detects an upward swipe operation (ACT 25). When the detection unit 2004 detects the upward swipe operation (Y in ACT 25), the display control unit 2005 displays the task menu screen on the operator display 114 (ACT 26). Then, the control unit 20 returns to the processing of ACT 21.

When the detection unit 2004 does not detect the upward swipe operation (N in ACT 25), the display control unit 2005 does not switch the screen and maintains the current screen being displayed (ACT 27). Then, the control unit 20 returns to the processing of ACT 21.

According to the second embodiment, the store clerk O who performs the screen switching operation need only recognize the relationship between the direction of the swipe operation and the switching screen. In this respect, the registration device 2 according to the second embodiment can facilitate the screen switching operation of the store clerk O.

### Third Embodiment

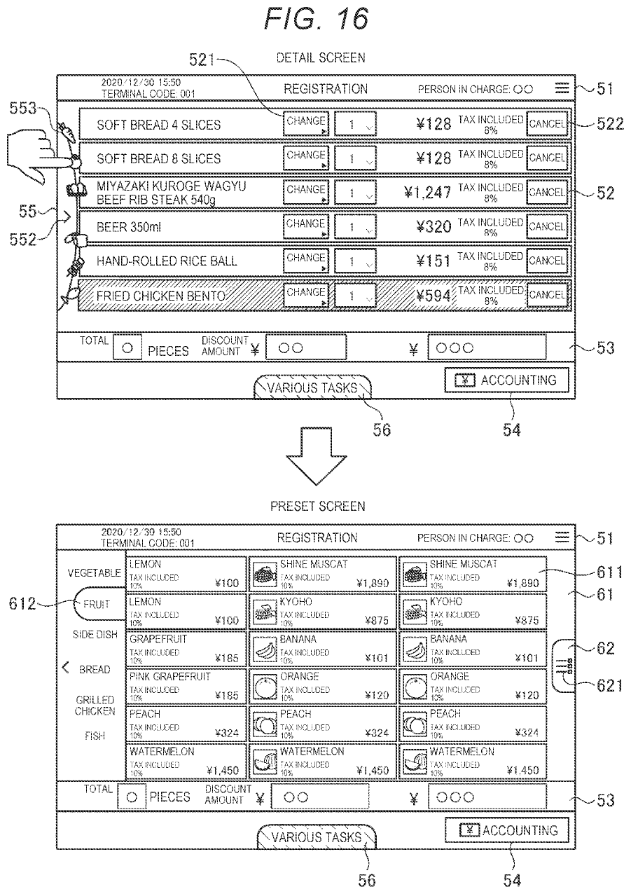

Next, a third embodiment will be described. The third embodiment is different from the first embodiment in a configuration of the preset display button 55 displayed on a detail screen. FIG. 16 is a diagram showing switching from the detail screen to a preset screen.

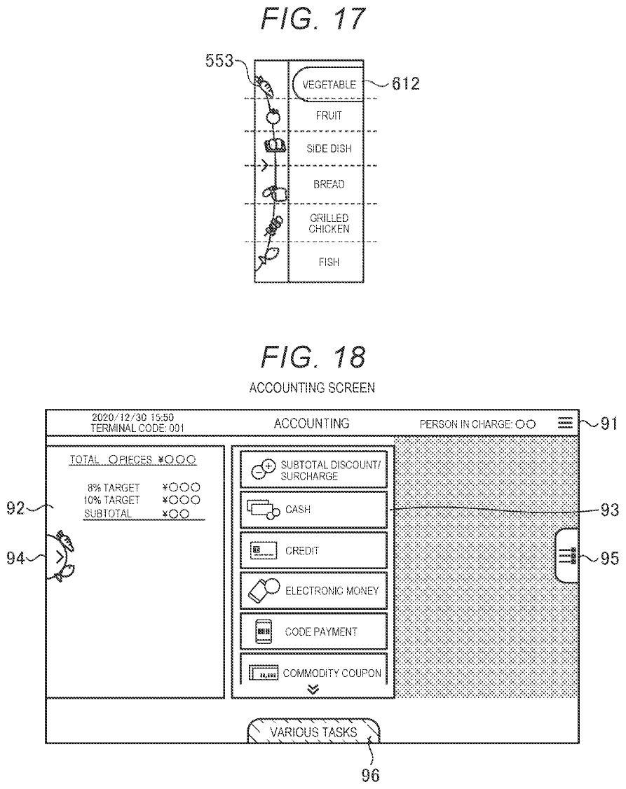

A plurality of classification 553 icons are additionally displayed on the preset display button 55 on the detail screen. FIG. 17 is a diagram showing the classification icons 553. As shown in FIG. 17, the classification icons 553 on the detail screen are respectively associated with specific tabs 612 on the preset screen.

The classification icons 553 include an icon corresponding to the tab 612 “vegetable”, an icon corresponding to the tab 612 “fruit”, an icon corresponding to the tab 612 “side dish”, an icon corresponding to the tab 612 “bread”, an icon corresponding to the tab 612 “grilled chicken”, and an icon corresponding to the tab 612 “fish”. Each of the classification icons 553 can be selected by the store clerk O.

When the store clerk O selects one of the classification icons 553 on the detail screen, the screen is switched to the preset screen on which the commodity selection buttons 611 for the classification of the tab 612 corresponding to the selected classification icon 553 are displayed. FIG. 16 shows that, when the classification icon 553 corresponding to the tab 612 “fruit” is selected, the screen is switched to the preset screen on which a plurality of commodity selection buttons 611 for “fruit” are displayed.

According to the third embodiment, when switching from the detail screen to the preset screen, the store clerk O can switch the screen to a preset screen on which the commodity selection buttons 611 for a specifically desired classification are displayed without first displaying a default preset screen. In this respect, the registration device 2 according to the third embodiment can facilitate a switching operation of the store clerk O from the detail screen to the preset screen.

### Fourth Embodiment

Next, a fourth embodiment will be described. In the fourth embodiment, an operator for switching among three screens is displayed on a screen other than a detail screen, a preset screen, or a task menu screen (hereinafter, collectively referred to as “three base screens”). In the fourth embodiment, an example will be described in which an operator for switching among the three base screens is displayed on an accounting screen of a POS terminal where the store clerk O performs operations related to commodity registration and payment. In other words, in the fourth embodiment, the POS terminal is an example of a registration device, and the accounting screen is an example of a screen other than the three base screens. The screen for displaying the operator for switching among the three base screens may be a screen displayed by the registration device before the customer C completes the payment, and may be, for example, a transfer screen displayed by the registration device 2 of a semi-self POS system.

FIG. 18 is a diagram showing the accounting screen of a POS terminal. The accounting screen is displayed, for example, when an accounting button is operated on the detail screen or the like after the commodity registration is completed. The accounting screen displays a header portion 91, a transaction information portion 92, an operation button portion 93, a preset display button 94, a detail display button 95, and a task menu display button 96.

The header portion 91 has the same configuration and function as the header portion 51 according to the first embodiment. The transaction information portion 92 displays a content of a transaction. For example, the transaction information portion 92 displays a total quantity, a total amount, an amount before tax, a subtotal amount, a discount amount, and the like of registered commodities. The operation button portion 93 displays various operation buttons. For example, the operation button portion 93 displays a button to be selected (operated) when making a discount based on a discount coupon brought by the customer C, and a button for selecting the payment method selected by the customer C.

The preset display button 94, the detail display button 95, and the task menu display button 96 have the same configurations and functions as the preset display button 55, the detail display button 62, and the task menu display button 56 according to the first embodiment, respectively.

According to the fourth embodiment, any one of three screens from the screen displayed before the customer C completes the payment, such as the accounting screen, can be displayed to the store clerk O. In this respect, the POS terminal according to the fourth embodiment can improve operability of the store clerk O.

As described above, there is provided a registration device 2 that registers commodity information for a commodity being purchased by a customer C. The registration device 2 includes: the operator display 114; the touch panel 113 provided on a surface of the operator display 114; the display control unit 2005 that selectably displays, on the operator display 114, a detail screen for displaying registered commodity information and a preset screen for displaying a plurality of commodity selection buttons for registering the commodity information; and the detection unit 2004 that detects a direction of a swipe operation of the store clerk O on the touch panel 113. The display control unit 2005 displays the preset screen on the operator display 114 when the detection unit 2004 detects that the direction of the swipe operation by the store clerk O is a preset first direction in a state in which the operator display 114 displays the detail screen.

Accordingly, the registration device 2 can switch display of the operator display 114 from the detail screen to the preset screen based on the swipe operation of the store clerk O. Therefore, the store clerk O can easily switch the screen to the preset screen even if the store clerk O cannot immediately recognize an operator for displaying the preset screen on the detail screen. Therefore, the registration device 2 can improve operability of a user regarding screen switching.

The display control unit 2005 of the registration device 2 displays the detail screen on the operator display 114 when the detection unit 2004 detects that the direction of the swipe operation by the store clerk O is a second direction opposite to the first direction in a state in which the operator display 114 displays the preset screen.

Accordingly, the store clerk O can easily switch the screen to the detail screen even if the store clerk O cannot immediately recognize an operator for displaying the detail screen on the preset screen. Since the direction of the swipe operation for switching from the preset screen to the detail screen is opposite to the direction of the swipe operation for switching from the detail screen to the preset screen, it is easy for the store clerk O to understand the swipe operation for switching from the preset screen to the detail screen. In this respect, the registration device 2 can also improve the operability of the user regarding the screen switching.

The display control unit 2005 of the registration device 2 according to the embodiment displays a task menu screen on the operator display 114 when the detection unit 2004 detects that the operation direction of the store clerk O is a preset third direction different from the first direction and the second direction in a state in which the operator display 114 displays the detail screen or the preset screen.

Accordingly, the store clerk O can display the task menu screen more easily by the swipe operation as described above.

The display control unit 2005 of the registration device 2 according to the embodiment displays the detail screen and the task menu screen on the operator display 114 when the detection unit 2004 detects that the operation direction of the store clerk O is the third direction in a state in which the operator display 114 displays the detail screen.

Accordingly, the store clerk O can efficiently perform a task that requires operating the detail screen and the task menu screen, such as commodity return processing during the commodity registration.

The display control unit 2005 of the registration device 2 according to the embodiment displays, on the detail screen, a switching button for displaying the preset screen, by locating the switching button on a start point side when the first direction is indicated by a start point and an end point.

Accordingly, the registration device 2 can display the preset display button 55 at a position, which is considered to be primarily focused on by the store clerk O who wants to display the preset screen. Therefore, the store clerk O can easily recognize the preset display button 55.

In the above embodiments, the control program executed by the registration device 2 may be provided by being recorded in a non-transitory, computer-readable recording medium such as a CD-ROM. The control program executed by the registration device 2 according to the above embodiments may be stored in a computer connected to a network such as the Internet and provided by being downloaded via the network, or may be provided by being accessed via a network such as the Internet.

While certain embodiments have been described, the embodiments have been presented by way of example only, and are not intended to limit the scope of the disclosure. The embodiments can be implemented in various other forms, and various omissions, substitutions, and modifications can be made without departing from the spirit of the disclosure.

What is claimed is:

1. A registration device, comprising:
a display unit for displaying various screens;
a touch panel input unit integrated with the display unit; and
a processor configured to:
cause the display unit to display a detail screen for displaying registered commodity information or a preset screen for displaying a plurality of commodity selection buttons for registering commodity information; and
detect an operation direction of a user input operation on the touch panel input unit, and then switch from a presently displayed screen to another display screen based on the detected operation direction and the presently displayed screen.

2. The registration device according to claim 1, wherein the processor is configured to switch to the preset screen when the detected operation direction is a first direction and the detail screen is the presently displayed screen and switch to the detail screen when the detected operation direction is a second direction different from the first direction and the presently displayed screen is the preset screen.

3. The registration device according to claim 2, wherein the processor is configured to switch to a third screen different from the preset screen and the detail screen when the detected operation direction is a third direction different from the first and second directions and the presently displayed screen is either one of the preset screen and the detail screen.

4. The registration device according to claim 3, wherein the third screen is a task menu screen on which a task can be selected by the user.

5. The registration device according to claim 3, wherein
the third screen is a partial task menu screen,
processor is further configured to switch to a full task menu screen when the detected operation direction is the third direction and the presently displayed screen is the partial task menu screen, and
the partial menu screen including portions of the detail screen and the full task menu screen.

6. The registration device according to claim 3, wherein the processor is configured to switch to the detail screen when the detected operation direction is the second direction and the presently displayed screen is the third screen.

7. The registration device according to claim 6, wherein the processor is configured to switch to the preset screen when the detect operation direction is the first direction and the presently displayed screen is the third screen.

8. The registration device according to claim 1, wherein
the detail screen includes a switching button for displaying the preset screen, and
the switching button is located adjacent to an outer edge of the preset screen, the outer edge being on a start point side of the first direction.

9. The registration device according to claim 8, wherein the switching button includes a plurality of category icons selectable to display a subset of items corresponding to the selected category icon.

10. The registration device according to claim 1, wherein the user input operation is a swipe operation.

11. A point-of-sale terminal, comprising:
a product scanner for registering commodities in a sales transaction;
a display unit for displaying various screens;
a touch panel input unit integrated with the display unit; and
a processor configured to:
cause the display unit to display a detail screen for displaying registered commodity information for commodities registered in the sales transaction or a preset screen for displaying a plurality of commodity selection buttons for registering commodity information in the sales transaction; and
detect an operation direction of a user input operation on the touch panel input unit, and then switch from a presently displayed screen to another display screen based on the detected operation direction and the presently displayed screen.

12. The point-of-sale terminal according to claim 11, wherein the processor is configured to switch to the preset screen when the detected operation direction is a first direction and the detail screen is the presently displayed screen and switch to the detail screen when the detected operation direction is a second direction different from the first direction and the presently displayed screen is the preset screen.

13. The point-of-sale terminal according to claim 12, wherein the processor is configured to switch to a third screen different from the preset screen and the detail screen when the detected operation direction is a third direction different from the first and second directions and the presently displayed screen is either one of the preset screen and the detail screen.

14. A registration method for controlling a registration device that registers commodity information for a sales transaction, the method comprising:
causing a display unit integrated with a touch panel input unit to display a detail screen for displaying registered commodity information or a preset screen for displaying a plurality of commodity selection buttons for registering commodity information; and
detecting an operation direction of a user input operation on the touch panel input unit, and then switching from a presently displayed screen to another display screen based on the detected operation direction and the presently displayed screen, wherein
when the detected operation direction is a first direction and the detail screen is the presently displayed screen, the display unit is switched to the preset screen, and
when the detected operation direction is a second direction different from the first direction and the presently displayed screen is the preset screen, the display unit is switched to the detail screen.

15. The registration method according to claim 14, further comprising:
switching to a third screen different from the preset screen and the detail screen when the detected operation direction is a third direction different from the first and second directions and the presently displayed screen is either one of the preset screen and the detail screen.

16. The registration method according to claim 15, wherein the third screen is a task menu screen on which a task can be selected by the user.

17. The registration method according to claim 15, wherein the third screen is a partial task menu screen.

18. The registration method according to claim 17, further comprising:
switching to a full task menu screen when the detected operation direction is the third direction and the presently displayed screen is the partial task menu screen, wherein
the partial menu screen includes portions of the detail screen and the full task menu screen.

19. The registration method according to claim 15, further comprising:
switching to the detail screen when the detected operation direction is the second direction and the presently displayed screen is the third screen.

20. The registration method according to claim 19, further comprising:
switching to the preset screen when the detect operation direction is the first direction and the presently displayed screen is the third screen.
